(19) United States
(12) Patent Application Publication
(10) Pub. No.: US 2026/0354309 A1
(43) Pub. Date: Nov. 12, 2026

(54) SEALING SYSTEM FOR AN AXIAL HARVESTER FEEDER MODULE

(71) Applicant: Vanderlei KAMPHORST, Horizontina (BR)

(72) Inventor: Vanderlei KAMPHORST, Horizontina (BR)

(21) Appl. No.: 19/487,394

(22) PCT Filed: Mar. 28, 2024
(86) PCT No.: PCT/BR2024/050127

§ 371 Date: Nov. 24, 2025

(30) Foreign Application Priority Data
Oct. 3, 2023 (BR) 1020230204090

(51) Int. Cl. A01F 12/26

(52) U.S. Cl. CPC A01F 12/26

(57) ABSTRACT

The present invention relates to a grain feeder module (32, 32a, or 32b), wherein said module is constructed from concave segments (1, 2, and 3) forming a cylinder (8) that can be assembled and disassembled to ensure serviceability. The assembly provides product sealing through specific sealing elements (9, 10, 11, and 21), preventing impurities resulting from the harvesting process from accumulating inside the cylinder.

### TECHNICAL FIELD

The present invention relates to the creation of a grain feeder module, where said module is constructed from concave segments forming the cylinder, capable of being assembled and disassembled, guaranteeing serviceability, such assembly ensures the tight sealing of the product, by means of specific seals, so that the impurities resulting from the harvest do not accumulate inside the cylinder, as it currently occurs.

### STATE OF THE ART

Axial rotor harvesters are machines in which the flow of threshed material follows along the axial threshing cylinder, mounted longitudinally on the machine body. As feeding occurs at the front, the actuation of the mechanisms is performed at the rear section. The feeding system of axial harvesters, from the cutting platform, passes through the feederhouse, which has a system of chains and slats. The transverse feeder module is composed of a series of blades on the outside for feeding the main rotor.

It is important to note that the function of the feeder module in a grain harvester is to drive the material of the chain conveyor, which is composed of chains and slats, up to the beginning of the industrial system which is the rotor (preventing formation of a dead triangle in this region). The feeder module is formed by bars or teeth that wrap around the cylinder and primarily provides a more homogeneous feed to the rotor, while avoiding threshing at this location to prevent damage to the grain. The grain thus arrives in homogeneous layers, and at the rotor inlet, the threshing process begins in the first section of the rotor. In this step, the threshed grain passes to the cleaning system via the concaves. The threshed material that has not detached from the straw in the threshing area continues to the rotor separation region. Subsequently, it enters the separation area, where it is separated and falls through the grates into the cleaning system in the form of straw and chaff, which then are conducted to the cleaning system. The feeder module is an important component for grain harvesting, since it influences the quality of the grains harvested, the performance of the machine and the fuel consumption.

In axial machines produced by various manufacturers, one or more axial rotors perform threshing at the front (about ⅓), and the remaining portion separates grain and straw. The cleaning system consists of air blower systems and sieves. The blower is driven by a shaft with blades powered by a mechanical or hydraulic system rotating around that shaft. This movement generates airflow, directed by the frame geometry into the sieve system, so that fine straw falling with the grain is blown away, preventing it from mixing with the clean grain in the sieves.

The John Deere feeder (cylinder) module, mounted on axial machines, is equipped with a series of radially arranged straight blades, mounted transversely, in either the original or rice configuration. These two models are interchangeable in terms of construction and serviceability, allowing the producer to exchange standard blade systems for rice blades according to machine model (e.g., John Deere S400, S600, S700) and vice versa. They are composed of five concave covers welded to form the feeder module, mounted radially or transversely on flanges and a shaft.

### PROBLEMS OF THE TECHNIQUE

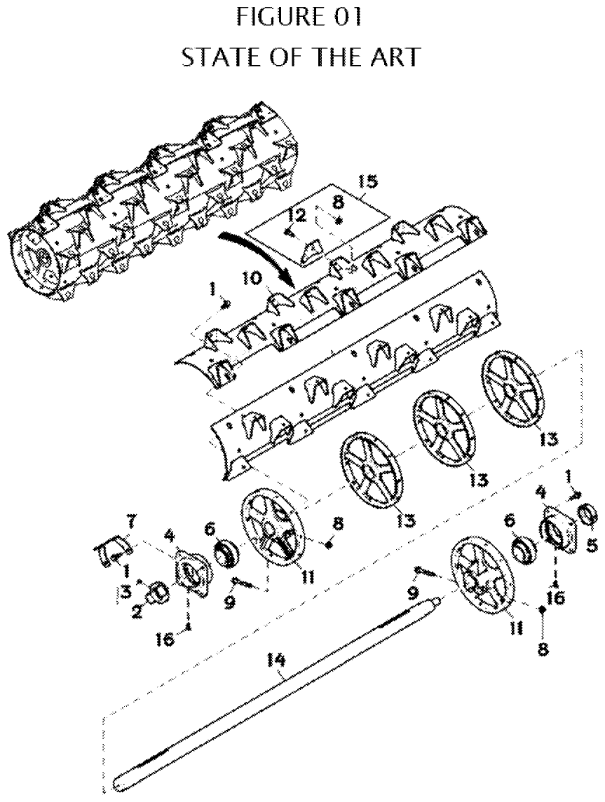

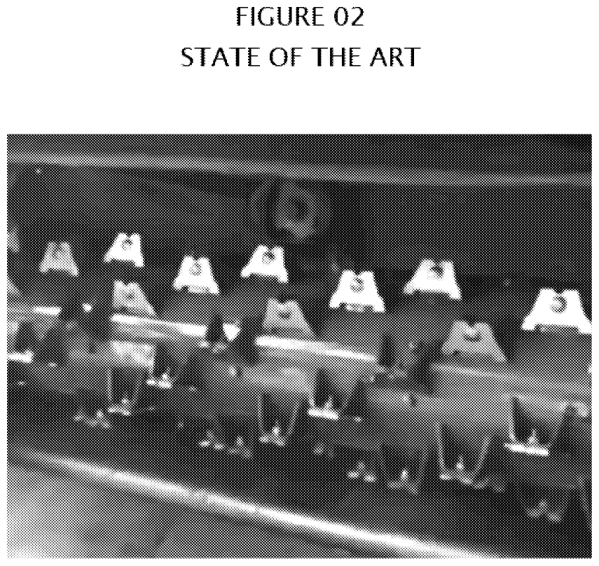

During the use of the grain harvester, the feeder module composed of welded concave segments presents the problem of accumulation of impurities on the inside, due to the existing gaps in its structural components. These impurities enter the cylinder through openings and gaps originating from the end covers and from the sides of the cylinder. This can be seen in FIGS. 01 and 02, which correspond to the state of the art.

These impurities generate vibrations in the harvester cabin due to the unbalancing caused by the non-uniform solid mass, and, if not properly cleaned, may cause fire, due to this dry mass being close to the heat-generating bearings, during.

### PROPOSED SOLUTION

Thus, in view of the problems identified in the prior art, one objective of the present invention is to develop a feeder module that prevents the entrance of impurities.

The proposed feeder module is constructed from concave curved plates forming a cylinder. In this construction system, these concave plates are joined together by screws, allowing easy assembly and disassembly, unlike welded assemblies which do not allow disassembly, as in the case of BR202021011209-9.

To prevent impurities from entering the joint regions of the concave plates, sealing devices have been developed. Three preferred sealing devices are exemplified, which can be used independently or in combination. These seals enable construction of a fully sealed, screw-fastened cylinder without welding, and without requiring a tube as a structural shaft.

### DESCRIPTION

The present invention is illustrated by drawings representing the sealing system for the feeder module of axial harvesters, so that the product can be fully reproduced using appropriate techniques, allowing complete characterization of the claimed functionality.

The descriptive part of the report is based on the figures illustrating the best or preferred embodiment of the invention, using detailed and consecutive numbering to clarify aspects represented, in order to clearly define the scope of protection sought herein.

These figures are merely illustrative and may present variations, provided that they do not deviate from the initially claimed invention.

The figures presented illustrate the following:

FIG. 01 shows an exploded perspective view of the feeder module of the prior art (John Deere S680 Combine);

FIG. 02 shows an assembled perspective of the John Deere S680 Combine feeder module in the rice system;

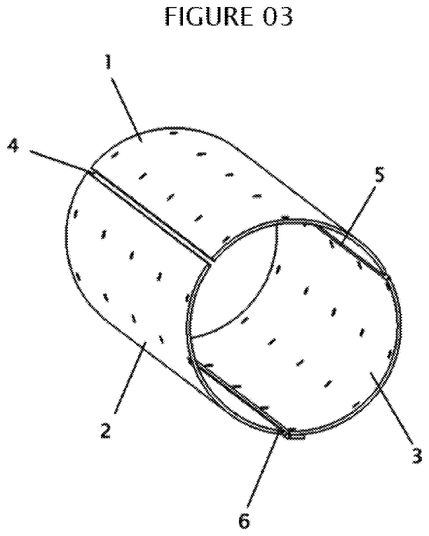

FIG. 03 shows the cylinder composed of three curved plates joined by fasteners, such as screws;

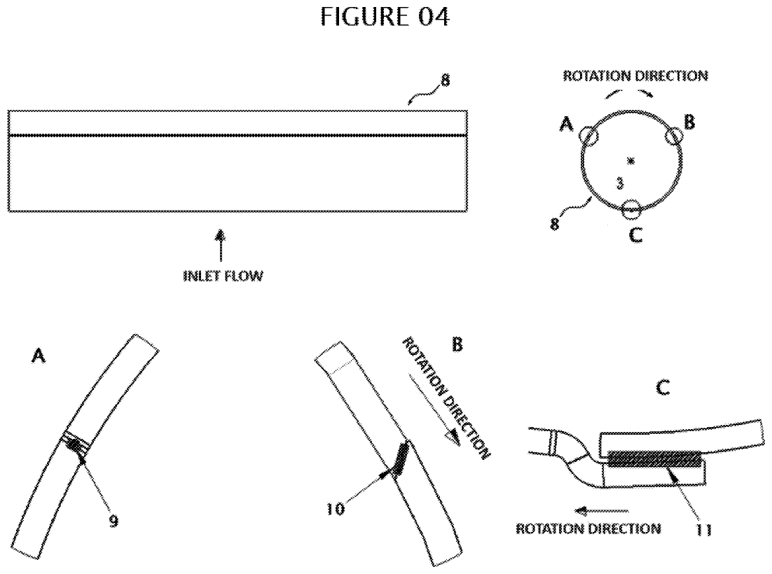

FIG. 04 shows three sealing possibilities (A, B, and C) for the bent plates forming the cylinder;

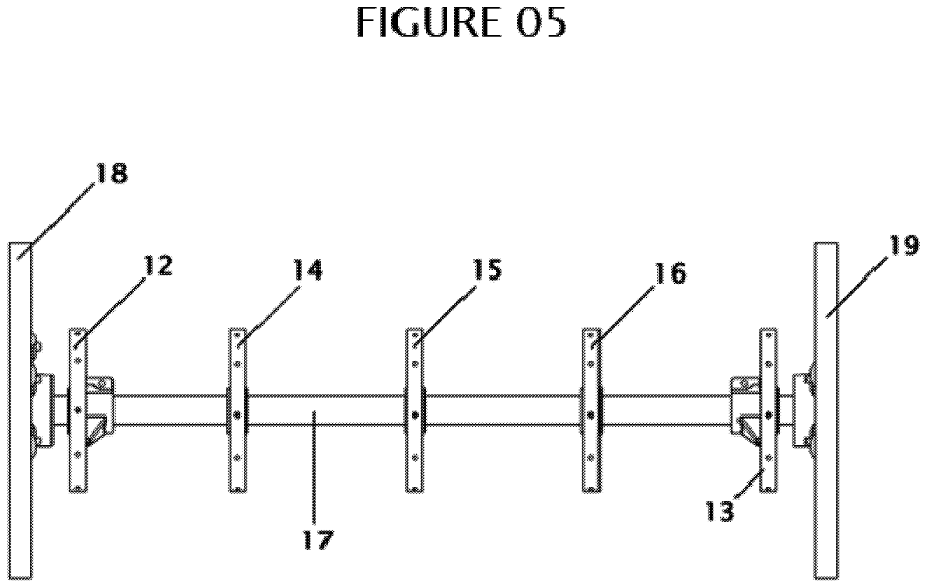

FIG. 05 shows a front view of the cylinder structure without the curved plates;

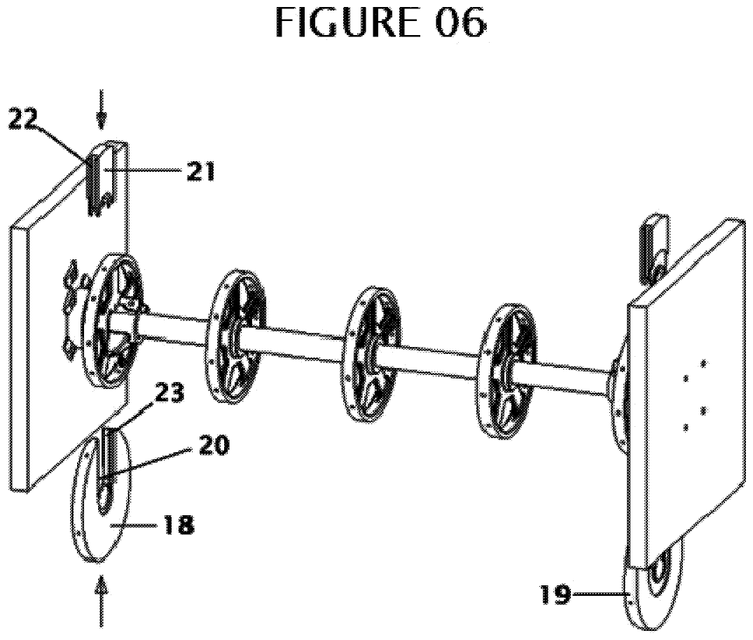

FIG. 06 shows assembly of the side seals of the cylinder structure using a drawer mechanism;

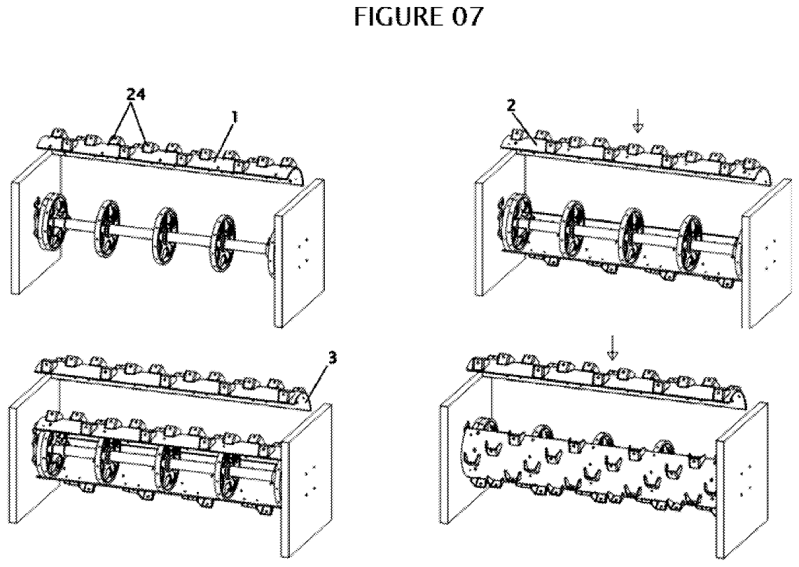

FIG. 07 shows four stages of assembly of the curved plates forming the cylinder of the proposed feeder module.

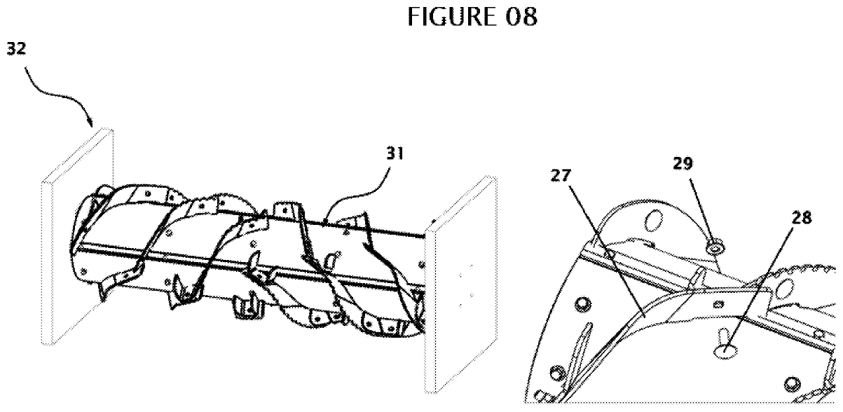

FIG. 08 shows the cylinder assembled from the curved plates containing metal inserts of the P11107417-5 system.

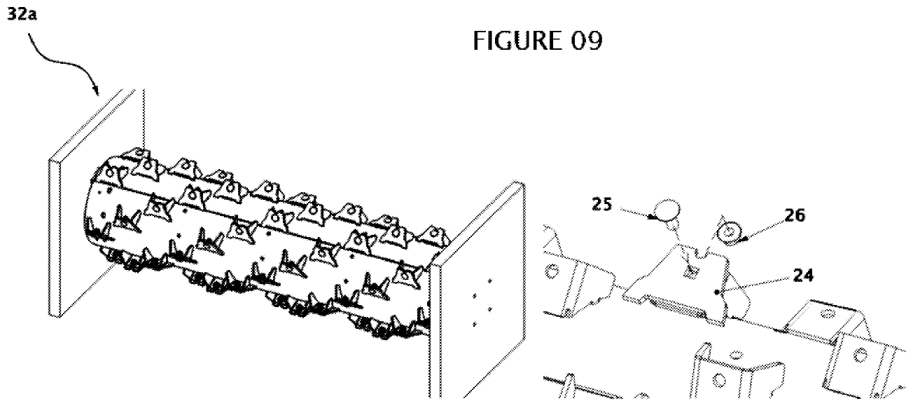

FIG. 09 shows the cylinder assembled from the curved plates containing metal inserts for the rice configuration;

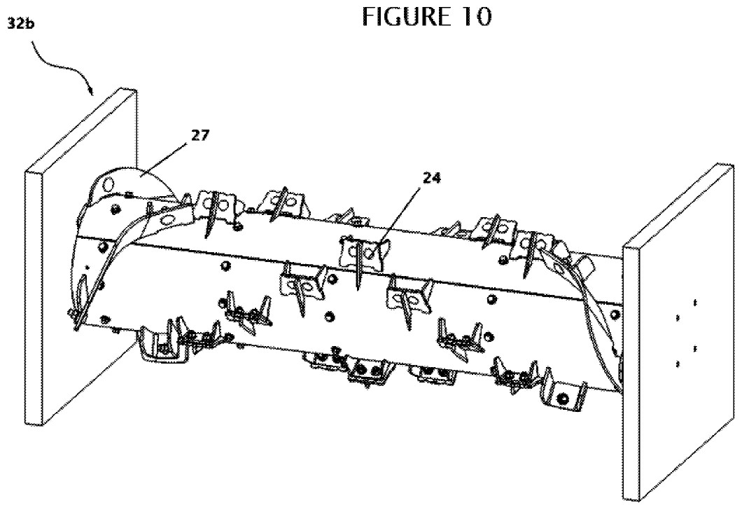

FIG. 10 shows the cylinder assembled from the curved plates containing hybrid metal inserts as in P11107417-5, and knife-type blades in the central portion;

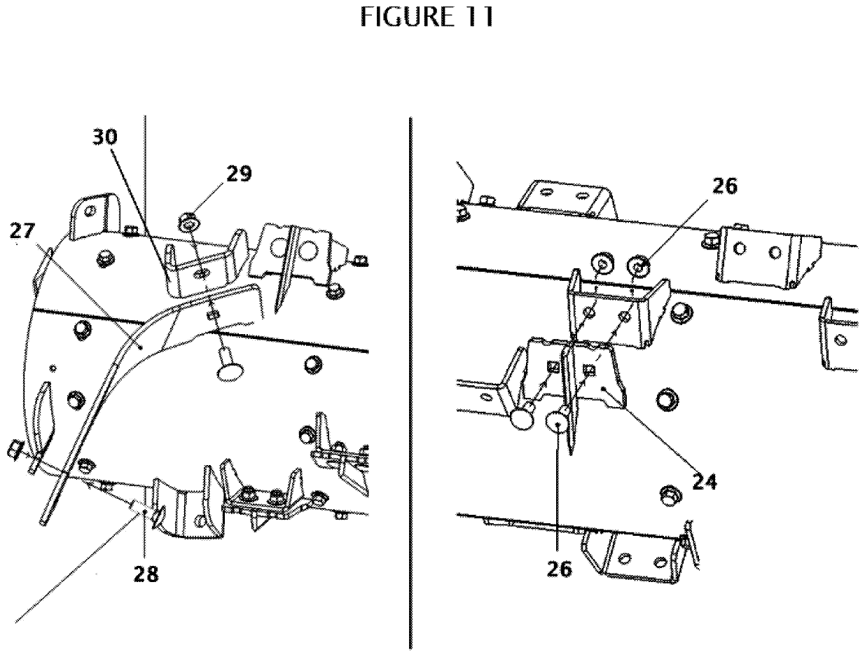

FIG. 11 shows details of the attachments of blades and knives.

The proposed invention employs three curved metal plates (1, 2, and 3) joined along connecting lines (4, 5, and 6) using fasteners, such as screws (7), forming a hollow cylinder (8).

The connecting lines (4, 5, and 6) include closure elements, preferably: an O-ring seal (9), a 45° chamfered seal using a band (10), and an overlapping joint made from a stamped sheet (11), thereby forming a side surface of the hollow cylinder (8) that is completely watertight.

The cylinder (8), formed by the curved metal plates (1, 2, and 3), has an internal structure comprising external flanges (12 and 13), internal flanges (14, 15, and 16), and a shaft (17), with both ends closed by circular covers (18 and 19).

The circular covers (18 and 19) have openings (20) through which slides (21) move, forming a two-part sealing system. These slides (21) include a set of ribs (22 and 23) which provide a sealed closure of the cylinder (8) at its ends, allowing reversible disassembly for maintenance and cleaning.

It is important to note that the feeder module (32a) is fully disassemblable by removing the slides (21), covers (18 and 19), and curved metal plates (1, 2, and 3).

The curved metal plates (1, 2, and 3) are shaped to receive a set of knives (24) attached to the side surface of the cylinder (8) using fasteners such as screws and nuts (25 and 26). Alternatively, the cylinder (8) may be equipped with a set of blades (27), also fastened with screws and nuts (28 and 29) into metal inserts (30) welded to the cylinder's side surface. Another alternative is a combination of knives (24) and blades (27), forming a hybrid system.

With this construction, it is possible to assemble the fully sealed feeder module, eliminating the need for a tube (mechanical or schedule), whether welded or seamless.

Some axial machines include a feed (input) cylinder and a rear (output) cylinder, which, after leaving the threshing system, passes through the rear cylinder before reaching the straw chopper/spreader. This rear cylinder has the same issue as the front cylinder, as previously mentioned. The present invention addresses both the input and output cylinders. Both cylinders use the same system of flanges and shaft (FIG. 03), with only the plates (1, 2, and 3) differing. Removing these plates (1, 2, and 3) exposes the structure shown in FIG. 03, with external flanges (12 and 13), internal flanges (14, 15, and 16), and the shaft (17). The tube (31), composed of crimped plates and inserts, is attached with screws to the original machine structure, forming the feeder module (32, 32a, or 32b).

At the ends of the tube (31), a two-part sealing system has been developed, comprising a drawer system (21) with screw fixation to prevent inflow of impurities through its ends, enabling lateral sealing without welding to the concave plates. This allows for the assembly of the new sealed system without the need to dismantle the machine's shaft. This seal is made of non-flammable and/or flame-retardant material.

After installing the side seals (18 and 21), the concave plates and crimped inserts are mounted. This system allows removal of the original covers and installation of the sealed system without dismantling the machine's feeder (mouthpiece).

With regard to the output cylinder (rear), it may comprise concave plates (1, 2, and 3) and crimped inserts (30) for a hybrid system, which includes knives (24) and knife-type blades (27) in the central portion, preventing the overload of the machine's original chopper system.

Key features of the proposed invention include feeder modules with a sealing system to prevent accumulation of debris in the cylinder center, avoiding the harvester's disbalance due to wear over time; improved serviceability, allowing module replacement without removing the feeder; and enhanced safety, as accumulation of dry material inside the cylinders, if not cleaned, could cause fire. For downstream or output modules, the hybrid system with knife-type blades helps chop straw and prevents overload of the machine's original chopper.

1. SEALING SYSTEM, comprising three curved metal plates (1, 2, and 3) forming a cylinder, wherein:
a) said curved metal plates (1, 2, and 3) are joined along the union lines (4, 5, and 6) by fasteners such as screws (7), forming a hollow cylinder (8);
b) said union lines (4, 5, and 6) include sealing elements, preferably a channel-type seal with O-ring (9), a 45° chamfer seal by means of a band (10), and an overlapping joint in a stamped plate (11), providing a leak-tight lateral surface for the hollow cylinder (8); and
c) the system includes circular covers (18 and 19) provided with slides (21) forming a bipartite sealing system that closes the cylinder (8) at its ends.

2. SEALING SYSTEM according to claim 1, wherein the cylinder (8), formed by the curved metal plates (1, 2, and 3), includes an internal structure defined by outer flanges (12 and 13), inner flanges (14, 15, and 16), and a shaft (17), with the two ends being closed by circular covers (18 and 19).

3. SEALING SYSTEM according to claims 1 and 2, wherein the circular covers (18 and 19) have openings (20) through which slides (21) move, forming a bipartite sealing system, and said slides (21) include a set of ribs (22 and 23) that ensure a leak-tight closure of the cylinder (8) at its ends.

4. SEALING SYSTEM according to claims 1, 2 and 3, wherein the curved metal plates (1, 2, and 3) are set to receive:
a) a set of knives (24) fixed to the lateral surface of the cylinder (8) by fasteners such as screws and nuts (25 and 26), forming the feeding module (32a);
b) a set of blades (27), also fixed by screws and nuts (28 and 29) on metallic inserts (30) welded to the lateral surface of said cylinder (8), forming the feeding module (32); and
c) a combination of knives (24) and blades (27), forming the hybrid system (32b).

5. SEALING SYSTEM according to any of the preceding claims, wherein the feeding module (32a) is completely detachable by removing the slides (21), covers (18 and 19), and curved metal plates (1, 2, and 3).
